(19) United States
(12) Patent Application Publication
(10) Pub. No.: US 2014/0183397 A1
(43) Pub. Date: Jul. 3, 2014

(54) Valve Module

(71) Applicant: FESTO AG & CO. KG, Esslingen (DE)

(72) Inventors: Martin Maichl, Salach (DE); Hannes Wirtl, Schongau (DE); Andreas Dickhoff, Kirchheim/Teck (DE)

(73) Assignee: FESTO AG & Co. KG, Esslingen (DE)

(21) Appl. No.: 14/118,450

(22) PCT Filed: Jul. 19, 2012
(86) PCT No.: PCT/EP2012/003052

§ 371 Date: Nov. 18, 2013

(30) Foreign Application Priority Data
Jul. 22, 2011 (DE) DE 102011108177.5

(51) Int. Cl. F16K 1/32

(52) U.S. Cl. CPC F16K 1/32
USPC 251/337; 137/15.18

(57) ABSTRACT

The invention relates to a valve module for influencing a fluid supply of a fluid-operated load, comprising a valve housing (4) which defines a valve chamber (17) with a fluidically communicating connection to an inlet port (18) and an outlet port (19), and further comprising a valve member (5) which is movably accommodated in the valve chamber (17) and which is adjustable along a movement axis (21) between a blocking position and a release position in order to influence a free flow cross-section between the inlet port (18) and the outlet port (19), and further comprising a spring mechanism (20) designed to apply a presettable preloading force to the valve member (5) in order to determine a preferred position of the valve member (5) in the valve chamber (17), characterised in that the spring mechanism (20) is supported, with an end region thereof which is remote from the valve member (5), on a supporting means (45) which can be located, within an adjustment range, in a freely selectable adjustment position relative to the valve housing (4).

The invention relates to a valve module for influencing a fluid supply of a fluid-operated load, comprising a valve housing which defines a valve chamber with a fluidically communicating connection to an inlet port and an outlet port, and further comprising a valve member which is movably accommodated in the valve chamber and which is adjustable along a movement axis between a blocking position and a release position in order to influence a free flow cross-section between the inlet port and the outlet port, and further comprising a spring mechanism designed to apply a presettable preloading force to the valve member in order to determine a preferred position of the valve member in the valve chamber.

The invention is based on the problem of providing a valve device which offers a precisely tolerable switching behaviour while allowing cost-effective production.

For a valve device of the type referred to above, this problem is solved by the features of claim 1.

According to the invention, it is provided that the spring mechanism is supported, with an end region thereof which is remote from the valve member, on a supporting means which can be located, within an adjustment range, in a freely selectable adjustment position relative to the valve housing. By setting the adjustment position for the supporting element, a preload or internal tension of the spring mechanism is determined, which in turn has a direct influence on the switching behaviour of the valve member. The valve member may optionally be moved by an electromechanical or fluidic actuator, for example by means of a solenoid coil or by means of fluidic activation, in particular using actuating means designed as a fluidic cylinder. This movement is at least substantially dependent on an actuating force provided by the actuator, on a spring force of the spring mechanism which opposes the actuating force and on friction forces generated by the movement of the valve member along the movement axis. Owing to the free adjustability of the supporting means, tolerances involved in the production of the individual components, in particular of the valve housing, the valve member and the spring mechanism, can at least to a great extent be compensated for in order to obtain a presettable switching behaviour for the valve member as a function of the actuating force.

Advantageous further developments of the invention are specified in the dependent claims.

It is expedient if the supporting means is designed for an end-side sealing of the valve chamber. This gives the supporting means an advantageous dual function, because, in addition to supporting the spring mechanism, it bounds the end of the valve chamber. This facilitates a simple and cost-effective construction of the valve device.

To fix the adjustment position, the supporting means is preferably connectable to the valve housing and/or to a valve insert by a substance-to-substance bond. By joining the supporting means to the valve housing and/or valve insert by a substance-to-substance bond, the supporting means is reliably located in the adjustment position. Moreover, machining operations such a thread cutting, which are complex in terms of manufacturing technology and which are commonly used to obtain an adjustable relative position between two components, can be omitted. For the substance-to-substance bond or adhesive joint, bonding methods and/or soldering methods and/or welding methods, preferably laser welding, can be used in particular.

In a further development of the invention, it is provided that the supporting means is, until it is located in the adjustment position, slidably placed in a recess of the valve housing or of a valve insert which can be installed into the valve housing. This ensures the desired free adjustability of the supporting means relative to the valve housing or the valve insert. The supporting means and the recess in the valve housing or in the valve insert are preferably matched to one another.

In a further development of the invention, a central axis of the spring mechanism is oriented parallel to the movement axis of the valve member. This allows for an advantageous utilisation of the spring energy which can be stored in the spring mechanism for presetting a preferred position for the valve member. This is in particular the case if the spring mechanism is designed as a helical spring.

It is advantageous if the valve member is slidably accommodated in a recess of the supporting means. The valve member and the recess in the supporting means are preferably matched to one another in such a way that there is very little, if any, free play in the direction perpendicular to the movement axis, so that the valve member is advantageously supported and guided by the supporting means. This is particularly advantageous in terms of the preload applied by the spring mechanism to the valve member and in terms of a desired high motion dynamic for the valve member aimed at obtaining switching times as short as possible. In a particularly preferred variant, the supporting means forms a sliding guide for the valve member.

In this context, it may be expedient if the valve member, together with the supporting means, bounds an in particular sealed reception space for the spring mechanism. This allows for a compact arrangement of the spring mechanism. If the reception space is pressure-tight, it can in addition act as a fluidic spring likewise forming a part of the spring mechanism owing to the fluid volume, in particular the air volume, which is enclosed in the reception space. This feature can be made use of, for example by giving the preferably provided helical spring smaller dimensions.

According to a further aspect, the problem of the invention is solved by a method according to claim 8. In this method, the following steps are provided: the installation of the valve member into the pressure chamber, the insertion of the supporting means and the spring mechanism supported thereon into the valve housing, the adjustment of a relative position of the supporting means in respect to the valve housing until, at a presettable test pressure and/or at a presettable test force acting on the valve member, a presettable volumetric fluid flow can pass through the pressure chamber and/or until a presettable position of the valve member relative to the valve housing and/or the valve insert is set, and the bonding of the supporting means on the valve housing and/or on the valve insert. In this process, it is advantageous that at least the components relevant to the switching behaviour of the valve device, i.e. the valve member, the spring mechanism and, depending on construction, either the valve housing or a valve insert which is to be installed into the valve housing at a later time and in which the valve seat is formed, are pre-assembled together with the supporting means to form an assembly. A subsequent step involves a test of the function of the assembly, wherein the switching behaviour of the valve member is tested and adjusted as a function of the action of external forces. For this purpose, a mechanical or fluidic pressure is applied to the valve member and the opening or closing of the free flow cross-section between the valve member and the valve seat in the pressure chamber is established. Depending on the established switching behaviour, the switching behaviour can, in a subsequent step, either be adjusted by increasing or reducing the preload applied by the spring mechanism to the valve member if the switching behaviour does not correspond to the preset requirements, or the supporting means can be located on the valve insert and/or on the valve housing if the switching behaviour is correct. The preloading force is adjusted by displacing the supporting means along the movement axis in order to obtain an increase or reduction in compression and therefore in the preloading force stored in the spring mechanism. In this case, the switching behaviour of the valve device is checked again until the preset correct switching behaviour can be set. The location of the supporting means on the valve insert and/or on the valve housing is preferably based on adhesive bonding, in particular laser welding.

An advantageous embodiment of the invention is illustrated in the drawing, in which:

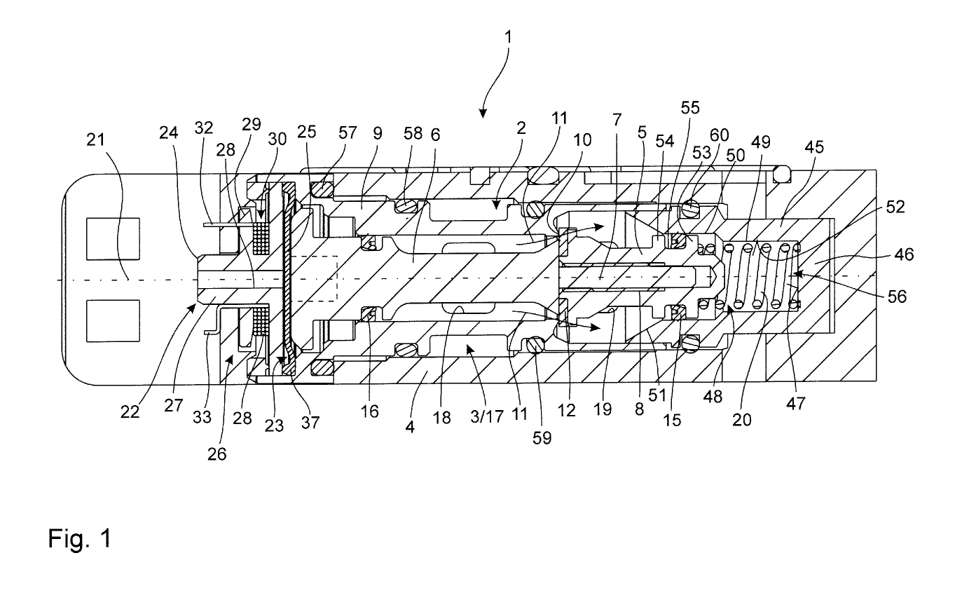

FIG. 1 is a sectional view of a valve module, and

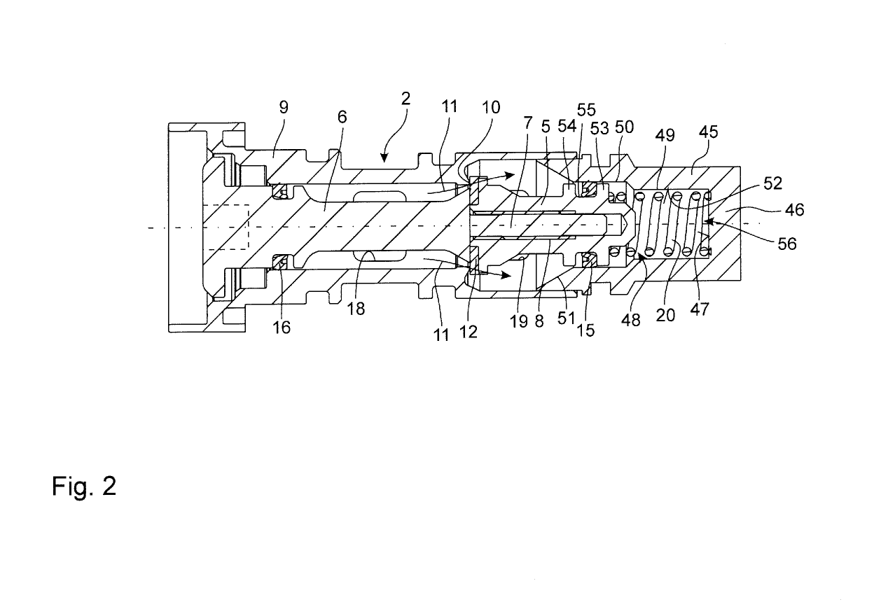

FIG. 2 shows an assembly of the valve module according to FIG. 1.

A sectional view of a valve module 1 according to FIG. 1 shows a valve body 2, which is designed in two parts in the illustrated embodiment and which is slidably accommodated in a valve recess 3 of a valve housing 4. The valve body 2 comprises a valve member 5 and an actuator 6, which are permanently joined to one another. For this purpose, a threaded section 7 is formed on the actuator 6 and a corresponding threaded blind hole 8 is formed in the valve member 5. The valve body 2 is slidably guided in a valve insert 9, which is in turn located in the valve recess 3 and which comprises an annular valve seat 10. As the valve body 2 is used to influence a free flow cross-section through a flow passage 11 edged by the valve seat 10, a continuous annular sealing washer 12 is provided between the valve member 5 and the actuator 6; in the neutral position according to FIG. 1, this is designed for a sealing contact with the valve seat 10, thereby blocking the flow passage 11.

Both the valve member 5 and the actuator 6 are in the illustrated embodiment sealed against the valve insert 9 by a lip sealing ring 15, 16 each and therefore bound a pressure chamber 17 together with the valve insert 9 and the valve housing 4. The pressure chamber 17 is connected for fluidic communication to a first supply passage not shown in detail via a first recess 18. Via a second recess 19, the pressure chamber 17 is connected for fluidic communication to an outlet passage which is likewise not shown in detail. By the interaction between the valve member 5 and the valve seat 10, a fluidically communicating connection can be established or blocked as required between the first recess 3 and the second recess 19 along the flow passage 11.

In the end region remote from the actuator 6, the valve member 5 is assigned a compression spring 20 which in the illustrated neutral position of the valve module 1 causes a blocking of the flow passage 11. To open the flow passage 11, a translational relative movement of the valve member 5 and the actuator 6 coupled thereto along the central axis 21 of the valve module 1 is required. In this process, the restoring force of the compression spring 20 has to be overcome. For this purpose, the actuator 6 is accommodated in a pilot chamber 23 defined by the valve insert 9 and an end plate 22. In the end plate 22, an operating passage 24 is formed through which fluid can be supplied to and discharged from the pilot chamber 23. For an advantageous seal between the pressure chamber 17 and the pilot chamber 23, a sealing membrane 25 is installed between the valve insert 9 and the end plate 22. When pressure is now applied to the pilot chamber 23, the actuator 6 and the valve member 5 coupled thereto are displaced, whereby the sealing washer 12 is lifted off the valve seat 10 and the flow passage 11 through the pressure chamber 17 is opened. The pressurised fluid required for this purpose is for example provided to the operating port 24 of the valve module 1 by a pilot valve not shown in the drawing.

In the illustrated embodiment, the end plate 22 is at least substantially rotationally symmetric relative to the central axis 21 and comprises a connector 27 through which an operating passage 28 passes. The operating passage 28 is designed for a fluidically communicating connection between the pilot chamber 23 and the operating port 24 and is in the illustrated embodiment a straight bore with a cylindrical cross-section. A continuous supporting ring 29 which, together with the end plate 22, defines an annular groove in which the coil arrangement 30 is accommodated is mounted on the connector 27. The connector 27 foil's the core for coil windings 31 of the coil arrangement 30, which in turn is a part of a sensor device 26.

The coil windings 31 are formed by winding an insulated piece of wire onto the connector 27. Diagrammatically illustrated wire ends 32, 33 of the coil arrangement 30 are connected to an AC source 34 and to a current metering device 35 series-connected to the AC source 34; these components are likewise a part of the sensor device 26.

The placing of the coil arrangement 30 concentric with the connector 27 allows for a small axial distance between the coil arrangement 30 and the valve member 5 as well as the actuator 6. The connector 27 further serves as a core and stabilises the coil arrangement 30. Furthermore, the free internal diameter of the coil arrangement 30, which has to be provided in any case, is used as an opening for the operating passage 28, resulting in a particularly compact construction for the valve module 1 with its integrated coil arrangement 30.

The sealing membrane 25, which is provided for separating the operating fluid in the pilot chamber 23 from the process fluid flowing through the pressure chamber 17, is contained between an end face region of the valve insert 9 and an opposite end face of the end plate 22. For an advantageous sealing action of the sealing membrane 25 against the associated end faces of the valve insert 9 and the end plate 22, a continuous bead 37 is provided on the sealing membrane 25, which bead 37, after the mounting of the end plate 22 on the valve housing 4, ensures a strong surface pressure in an annular region and therefore an advantageous sealing action for the sealing membrane 25. The surface pressure of the bead 37 is provided by the end plate 22, which is in turn held by a cover plate 38 mounted at the end face of the valve insert 9, in particular using adhesive force. With an inner surface facing the end plate 22, the cover plate 38 compresses a sealing ring 39, which in turn bears against a surface of the end plate 22 which faces the cover plate 38. The wire ends 32, 33 of the coil arrangement 30 pass through the cover plate 38. As the coil arrangement 30 is not placed in a pressurised region, there is no need for sealing the bushings for the cable ends 32, 33.

The sealing membrane 25 is designed such that it is deformed only elastically within the valve stroke, which is substantially determined by the geometry of the valve member 5 and the valve insert 9.

The compression spring 20 bearing against the valve member 5 with a first end region is supported on a supporting means 45 in a second end region remote from the valve member 5. In the illustrated embodiment, the supporting means 45 is designed as a cylindrical sleeve in sections. The supporting means 45 is preferably rotationally symmetric relative to the central axis 21. In an end region remote from the valve member 5, the sleeve-like supporting means 45 of the illustrated embodiment is provided with a cover plate 46, the inner surface 47 of which serves as a contact surface for the compression spring 20. The compression spring 20 is accommodated in a stepped recess 48 of the supporting means 45. In the illustrated embodiment, a first part-section 49 of the recess 48, which adjoins the cover plate 46, is cylindrical and has an internal diameter which so matches an external diameter of the compression spring 20 that the coils of the compression spring 20 can move freely while being supported on the inner wall 52 of the first part-section 49 if required. The first part-section 49 is adjoined by a second part-section 50 of the recess 48, which is likewise cylindrical in the illustrated embodiment. The second part section serves as a receiving section, in particular in the manner of a plain bearing, for an end region of the valve member 5. In the illustrated embodiment, the valve member 5 is designed for a slidably sealed installation into the second part-section 50 and is for this purpose provided with two continuous flanges 53, 54. The flanges 53, 54 are axially spaced along the central axis 21, thereby bounding a continuous groove 55. The groove 55 accommodates the lip sealing ring 15, which provides a radial seal between the valve member 5 and the supporting means 45. The sealed placement of the end region of the valve member 5 in the supporting means 45 provides a closed fluid chamber 56 which, when filled with a compressible fluid, in particular air, acts on the valve member 5 as a fluidic spring in addition to the action of the compression spring 20. Acting together with the second part-section 50, the flanges 53, 54 further act as a mechanical guide for the valve member 5. The second part-section 50 is adjoined by a third part-section 51, which is designed as a conical section and in particular acts as an insertion region for the lip sealing ring 15 when the supporting means 45 is mounted on the end region of the valve member 5.

When assembling the valve module 1, the actuator 6 is first fitted with the lip sealing ring 15 and inserted into the valve insert 9 along the central axis 21. The sealing washer 12 is then pushed onto the threaded section 7 of the actuator 6. In a further assembly step, the valve member 5 provided with the lip sealing ring 15 is screwed onto the threaded section 7 of the actuator 6 by its threaded blind hole 8, whereby the sealing washer 12 is located between opposite annular flat surface regions of the valve member 5 and the actuator 6. Finally, the supporting means 45 is fitted with the compression spring 20 and pushed onto the valve member 5 in such a way that the flanges 53, 54 and the lip sealing ring 15 held in between come to lie in the second part-section 50 of the recess 48.

The assembly produced in this way is then placed in a testing apparatus not shown in detail, where a force can be introduced into the actuator 6 which opposes the preloading force applied by the compression spring 20 to the valve member 5 along the central axis 21. The force applied to the actuator 6 is preferably introduced as a mechanical compressive force, and a pressurised fluid is made available via the supply recess 18. With a suitably designed testing apparatus, the volumetric flow rate along the flow passage 11 from the supply recess 18 to the outlet recess 19 can be detected, thereby determining the switching behaviour of the valve member 5. In the testing process, the force can be increased, preferably steadily, by increasing the pressure acting on the actuator 6. As soon as the force acting on the actuator 6 exceeds the preloading force of the compression spring 20, the sealing washer 12 motion-coupled to the valve member 5 is lifted off the valve seat 10, and the fluid can flow along the flow passage 11. If at this point in time, which can also be referred to as opening point, the compressive force acting on the valve member 5 is within a presettable range, the supporting means 45 can be located on the valve insert 9. If the compressive force acting on the actuator 6 is outside the presettable range, the supporting means 45 is, if the compressive force is too high, moved away from the valve member 5 by a presettable amount along the central axis 21; in the other case, the supporting means 45 is moved closer to the valve member 5 by a presettable amount. This process is repeated until the compressive force at the switching point lies within the preset range, whereupon the supporting means 45 is bonded to the valve insert 9.

In a subsequent assembly step, the valve insert 9 with the components installed therein can be provided with sealing rings 57, 58, 59, 60 and inserted into the valve housing 4. In this process, the valve insert 9 together with the installed actuator 6 and the sealing rings 58, 59 forms a first pressure chamber 17 to which pressure can be applied via the recess 18. If the sealing washer 12 is lifted off the valve seat 10, this pressure chamber 17 is fluidically coupled to the outlet recess 19, allowing pressurised fluid to flow from the pressure chamber 17 into the outlet recess 19.

1. A valve module for influencing a fluid supply of a fluid-operated load, comprising a valve housing which defines a valve chamber with a fluidically communicating connection to an inlet port and an outlet port, and further comprising a valve member which is movably accommodated in the valve chamber and which is adjustable along a movement axis between a blocking position and a release position in order to influence a free flow cross-section between the inlet port and the outlet port, and further comprising a spring mechanism designed to apply a presettable preloading force to the valve member in order to determine a preferred position of the valve member in the valve chamber, wherein the spring mechanism is supported, with an end region thereof which is remote from the valve member, on a supporting means which can be located, within an adjustment range, in a freely selectable adjustment position relative to the valve housing.

2. A valve module according to claim 1, wherein the supporting means is designed for an end-side sealing of the valve chamber.

3. A valve module according to claim 1, wherein the supporting means is connectable to the valve housing and/or to a valve insert by adhesive bonding to fix the adjustment position.

4. A valve module according to claim 3, wherein the supporting means is, until it is located in the adjustment position, slidably placed in a recess of the valve housing or of a valve insert which can be installed into the valve housing.

5. A valve module according to claim 3, wherein a central axis of the spring mechanism is oriented parallel to the movement axis of the valve member.

6. A valve module according to claim 4, wherein the valve member is slidably accommodated in a recess of the supporting means.

7. A valve module according to claim 6, wherein the valve member, together with the supporting means, bounds a reception space for the spring mechanism.

8. A Method for producing a valve module according to claim 1, comprising: the installation of the valve member into the pressure chamber, the insertion of the supporting means and the spring mechanism supported thereon into the valve housing, the adjustment of a relative position of the supporting means in respect to the valve housing until, at a presettable test pressure and/or at a presettable test force acting on the valve member, a presettable volumetric fluid flow can pass through the pressure chamber and/or until a presettable position of the valve member relative to the valve housing and/or the valve insert is set, and the bonding of the supporting means on the valve housing and/or on the valve insert.
